(19) United States
(12) Patent Application Publication
(10) Pub. No.: US 2013/0181386 A1
(43) Pub. Date: Jul. 18, 2013

(54) PNEUMATIC COUPLING MODULE, IN PARTICULAR FOR A ZERO-POINT CLAMPING SYSTEM FOR A MACHINE TOOL

(71) Applicant: Klaus Hofmann, Bruck (DE)

(72) Inventor: Klaus Hofmann, Bruck (DE)

(21) Appl. No.: 13/822,614

(22) PCT Filed: Sep. 14, 2011
(86) PCT No.: PCT/DE11/75219

§ 371 Date: Mar. 12, 2013

(30) Foreign Application Priority Data
Sep. 15, 2010 (DE) 10 2010 037 545.4

(51) Int. Cl. B23Q 3/00

(52) U.S. Cl. CPC B23Q 3/00
USPC 269/20

(57) ABSTRACT

The invention relates to a pneumatic coupling module, in particular for a zero-point clamping system, with a least one pneumatically operable coupling device, to which the pneumatic medium can be fed via a supply channel and which is constructed in such a manner that the coupling device occupies a release position in its pressurized state and a locked position in its non-pressurized state, wherein the coupling module comprises an interface area for coupling another pneumatic coupling module or a pneumatically operable working module. According to the invention, a directional valve is provided in the supply channel, comprising a first port, which is connected to a first part of the supply channel, which feeds the pneumatic medium, a second port, which is connected to a second part of the supply channel, which leads from the directional valve to the coupling device, and a third port, which is connected to a supply coupling channel, the at least one outlet opening of which is arranged in the interface area in such a manner that the outlet opening can be coupled in a substantially sealed manner to at least one inlet opening of a supply channel or a manifold supply channel of an additional pneumatic coupling module or pneumatically operated working device, wherein the directional valve connects the first and the second ports in a first switching position (“INTERNAL”) in such a manner that the first and second parts of the supply channel are connected and the coupling device is controlled to assume its release position and wherein the directional valve disconnects the first port from the third port in the first switching position, whereby no pneumatic medium can be fed to the supply coupling channel, and wherein the directional valve disconnects the second port from the first port in a second switching position (“EXTERNAL”) and connects the first and third ports in such a manner that the first part of the supply channel is connected to the supply coupling channel and pneumatic medium can be fed to the supply coupling channel and that no pneumatic medium can be fed via the second part of the supply channel to the coupling device and it is controlled to assume the locked position. The invention further pertains to a modular clamping position consisting of such coupling modules.

The present invention elates to a pneumatic coupling module, in particular for a zero-point clamping system, with the characteristics of the preamble of claim 1, and to a modular clamping system in accordance with claim 12, in particular for a machine tool having such coupling modules.

In machine tools of the type known from the prior art, workpieces that are being machined can be fixed for this purpose in various manners within the machining range of the machine tool. For example, devices are known in which the workpiece is bolted via a collet against a machine bed and released by appropriate loosening of the threaded connection. In addition, clamping devices are known that are bolted onto the working table of the machine and are specifically constructed or arranged for a given workpiece. When the workpiece or the workpiece type is changed, the clamping device must be disassembled and set up again each time, and the zero-point or reference point must be determined again.

It is also necessary or desirable under certain circumstances to arrange and fix several workpieces simultaneously in the machining area of a machine or to remove them therefrom. For this purpose, the workpieces can be arranged together on a carrier such as a pallet in order to then be fixed as a whole in the machining area of the tool. After machining is finished, the carrier is detached as a whole from the fixation and removed.

Clamping devices in which a fixation element, which is used directly or indirectly as the carrier of a workpiece to be machined, is lockably inserted into a receptacle are generally known. The locking or detachment is equivalent to the fixation or release of a fixation element. These known clamping devices, however, are complicated in structure and are cumbersome to use.

Therefore, so-called zero point systems for fixing workpieces in the machining area of a machine tool were developed, making it possible to fix the workpieces themselves or carriers for workpieces, in the form of pallets for example, with high and reproducible accuracy in the machining area of a machine tool. Such a device is known from WO 2007/009439 A1, for example. In this device, a pin-like engagement element, which can be provided on the workpiece itself or on a workpiece carrier, is locked with a high precision by means of a pneumatically operable clamping element. In a base plate arranged fixedly in the machine tool, preferably several such clamping units can be arranged in a predetermined grid, so that a workpiece or workpiece carrier with one or more engagement elements can be introduced into the machining area of the machine tool easily, quickly and with extremely high reproducibility of position relative to the machine tool.

In order to fix different workpieces, however, they must each be furnished with an engagement element or several engagement elements that correspond to the grid, which is predetermined by the clamping units provided in the machining area of the machine tool. The same applies to the usage of carriers for one or more workpieces, with engagement elements arranged thereon. For easy clamping of complicated workpieces or workpieces in defined positions, it remains necessary to use additional clamping devices, either directly in the machining area or on a workpiece carrier, the assembly or construction of which in the machining area is either impossible due to the relatively large scale of the clamping units or is expensive. The remedy of mounting the workpiece on a carrier also requires corresponding expense and effort for the assembly of corresponding fixation or clamping units on the carrier.

Arranging clamping or tensioning modules, likewise pneumatically operable, i.e. shifted from a released position into a clamping position and vice versa, on the carrier is also known in this context. A considerable part of the expense of assembling a clamping or tensioning module or a coupling module such as a carrier, which in turn has pneumatically operable clamping units, results from the fact that separate pressure lines for the pneumatic medium are necessary for each unit.

Starting from this prior art, the problem addressed by the invention is to create a modular clamping system, in particular for a machine tool, and corresponding coupling modules, with which it is possible to fix an element for fixation, in particular a workpiece, easily, quickly and with high reproducibility of the fixation position in a predetermined area.

The invention solves the problem with the characteristics of claims 1 and 12. Further configurations of the invention follow from the subordinate claims.

The invention originates from the recognition that an element for fixation such as a workpiece can be fixed in a predetermined position in a simple manner by means of pneumatically lockable and releasable modules if a modular clamping system is used that makes it possible to put together a desired clamping element from several coupling modules in a modular manner, wherein the pneumatic medium is not supplied to the individual modules via respectively separate compressed air lines, in particular compressed air hoses, but instead from the respective preceding module to the module coupled thereto. The coupling module is constructed in such a manner that at least one pneumatically operable coupling device is provided that assumes a locked position when not subjected to pressure, while a shift from the locked position to the release position takes place when pressure is applied.

The pneumatic medium is supplied to the at least one coupling device via a supply channel in which a directional valve is arranged. The directional valve can be transferred from a position “INTERNAL” to a position “EXTERNAL” manually or via a control unit. In the “INTERNAL” position, the directional valve switches the supply channel in such a manner that the at least one coupling device is brought into the release position. In the “EXTERNAL” position, the directional valve disconnects the supply channel, so that the at least one coupling device is brought into the locked position. At the same time, the directional valve in this position connects the first part of the supply channel (between a supply opening and the directional valve) to a supply coupling channel, which makes it possible to route the pneumatic medium through the respective coupling module to at least one outlet opening, which is situated in an interface area at which the coupling module can be connected to another pneumatic coupling module or a pneumatically operable working module. In the “INTERNAL” state, on the other hand, the supply coupling channel is disconnected from the first part of the supply channel that supplies a pressure medium, so that no pressure medium can escape via the supply coupling channel in the release position of the coupling device.

A working module is ordinarily located at an endpoint of a series of several coupled coupling modules and can also be formed as a purely manually operable working module in place of having a pneumatic actuation. In this case, it is not necessary to provide the working module with a supply channel for the pneumatic medium.

In principle, a supply channel can branch upstream or downstream of the directional valve into several respective arms, wherein each arm existing downstream of the valve can lead to a respectively different coupling device. The respective coupling devices are then operated jointly, i.e. shifted into the locked position or the release position. For this purpose, the directional valve must be in the “INTERNAL” position. Several arms upstream of the directional valve can make it possible to feed the pressure medium to the supply channel via several paths (and feed openings). This can of course take place simultaneously, for example to increase safety, or alternately, for example, to enable different coupling positions, only one or selected feed openings are provided with pneumatic medium in each case.

The coupling devices associated with the respective directional valve are generally actuated by means of an additional valve, which connects or disconnects the supply channel to the pressure source. It is possible for several supply channels to be provided in one coupling module, in which case each supply channel is assigned a separate feed opening for the pressure medium, or a manifold supply channel can be used, from which the different supply channels branch off, in each of which a directional valve is provided. A separate coupling channel is assigned to each of these individual supply channels of course. Each coupling channel can of course also branch into several arms, so that the pneumatic medium routed via the arms of the coupling channel is transferred via several outlet openings to the subsequent coupling or working module. The multiple arms can either be used to transfer the pneumatic medium simultaneously via several paths to the subsequent module, or can make it possible to couple the subsequent module in different positions, the feed opening in each of the different positions being aligned with an outlet opening of the supply coupling channel or channels (or the respective arms).

In a similar manner, at least one detector channel, to which pneumatic medium can be fed, can be provided in each coupling module, each detector channel being constructed in such a manner that its cross section is reduced or completely closed in the presence of an engagement element in the locked position of the associated coupling device, so that the presence of an engagement element or the correct positioning of the engagement element in the locked position can be detected by a measurement of pressure, differential pressure or flow rate. Reduction of the opening cross section is also understood to include the variant in which an outlet opening of the detector channel is closed off by an engagement element of the downstream coupling or working device received in the locked position of the at least one coupling device associated with the detector channel, or the flow resistance is increased to such an extent that the presence of an engagement element is detectable.

Thereby it can be determined, and checked if required, in a simple manner whether an engagement element or the respective downstream module is properly locked in the coupling device.

In the same manner as that described for the supply channel, the pneumatic medium fed to the detector channel can be fed by means of a distribution valve provided therein either to the part of the detector channel leading to the detector point, or to a detector coupling channel that is used to route the pneumatic medium to the downstream module for “detector purposes.” This at least one directional valve consequently also has an “INTERNAL” position and an “EXTERNAL” position, the “INTERNAL” position allowing the detector function in the respective module and the “EXTERNAL” position allowing the routing of the pneumatic medium to the respectively next module.

It is not absolutely necessary that the pneumatic medium be used for detector purposes in the respective subsequent module. It can also be provided in the same manner to the supply channel of the subsequent module, while the pneumatic medium routed in the respective module via the supply coupling channel is fed to the detector channel of the subsequent module. However, in the driving of the coupling device for the respective last module in the chain of coupled modules, or for executing the detector function, it is necessary to know which channel of the first module in the chain must be subjected to pressure (for detaching the coupling device(s) of the last module) or which channel of the first module is the one at which the detector function must be executed (measurement of the pressure or the flow rate or the pressure drop of the pneumatic medium at a first flow resistor).

The detector channel can of course have several arms upstream and/or downstream of the valve. All the arms downstream of the valve can either lead to the same coupling device in order to realize the detector function there with higher security, or to different coupling devices, in which case the monitoring responds even if the flow resistance in one of the arms is reduced because the engagement element in question is no longer properly locked.

Several arms of the detector channel can be provided upstream of the directional valve in question for the same reason as described in connection with the division of the supply channel downstream of the directional valve.

According to a preferred embodiment of the invention, the at least one coupling device has at least one separate coupling unit which is housed in a main body of the coupling module in the interface area, wherein the at least one directional valve is provided in the main body. This variant allows the separate production of the coupling devices as autonomous units, which then need only be inserted into the main body of the coupling module. This also allows an easy replacement of defective coupling units.

h of the separate coupling units can also comprise at least one channel that forms a part of the respective supply coupling channel, the at least one outlet opening of the respective supply coupling channel being preferably provided on the coupling unit. Thus the separate coupling unit forms at least a substantial part of the interface area. The at least one channel that forms the part of the supply coupling channel in the coupling unit can be produced by a simple drill hole, for instance.

logously to this, each coupling unit can also comprise at least one channel forming a part of the respective detector coupling channel, the at least one outlet opening of the respective detector coupling channel being preferably provided on the coupling unit.

According to one configuration of the invention, at least two coupling devices can be provided, with the at least two first parts of the supply channels branching off from a single manifold supply channel to which pneumatic medium can be fed via a feed opening. Thereby the pressure can be applied centrally to the supply channels (after the necessary controlling of the directional valves in the supply channels).

course, in the case of at least two coupling devices, the at least two first parts of the detector channels can also branch off a single manifold detector channel to which pneumatic medium can be fed via a feed opening. This yields the possibility of also supplying the monitoring pneumatic medium at a central point.

Coupling module according to the invention can also comprise an additional interface area, with which the coupling module can in turn be coupled to a first interface area of an additional coupling module, wherein at least one engagement element for engaging in the coupling device of the additional coupling module is provided in the additional interface area, and wherein at least one feed opening of the supply channel or the manifold supply channel and, if necessary, also at least one feed opening of the detector channel or manifold detector channel is arranged in the additional interface area in such a manner that said opening can be connected to the at least one outlet opening of the supply coupling channel or the detector coupling channel of the additional coupling module in a substantially sealing manner. Thus such a coupling module can be locked with its additional interface area to a preceding coupling module and can be connected to a downstream coupling or working module with the interface area in which the at least one coupling device is provided.

The coupling module according to the invention can have a main body formed in two parts, wherein a first part of the main body comprises the at least one coupling device and a second part of the main body comprises the at least one engagement element and the two parts of the main body can be guided movably relative to one another with at least one degree of freedom, preferably about a single rotational axis or in a single translational direction.

It has proved to be advantageous to provide the at least one directional valve in the supply channel and, if applicable, the at least one directional valve in the detector channel in the second part of the main body because the valves remain stationary and the accessibility of the valves cannot be impaired by the movement of the two main body parts relative to one another.

The modular clamping system according to the invention, in particular for a machine tool, consists of several types of differently formed coupling modules according to one of the preceding claims, wherein the types of coupling modules with respect to the engagement elements and with respect to the feed openings for the supply channels or manifold supply channels, and, if applicable, the feed openings for the detector channels or the manifold detector channels, and with respect to the outlet openings of the supply coupling channels and, if applicable, the outlet openings of the detector coupling channels are constructed in such a manner that similar and differently formed coupling modules can be coupled at least in predetermined combinations. This allows a plurality of different combinations of several identical or different types of coupling modules, so that practically every problem for clamping an element for fixation, such as a workpiece in a given position and location, can be solved with a small number of different (or also identical) coupling elements.

The invention provides a modular system in the form of different types of pneumatic coupling modules and working modules, which can be coupled and combined with one another in multiple manners, without each coupling module having to be separately connected to the pneumatic pressure source via a pressure line or a pressure hose for supplying the pneumatic medium.

After the coupling of a second coupling module to a first coupling module, or the coupling of an additional downstream coupling module to a preceding coupling module, the one or more directional valves that are associated with the coupling devices that lock a respective engagement element of the second or following coupling module are switched from the “INTERNAL” position to the “EXTERNAL” position, so that the pneumatic medium can be routed to the second or downstream coupling module. The same applies to the directional valves for the optional detection of the proper locked position of the engagement elements of the second or downstream coupling module in the respective coupling device of the first or preceding coupling module.

The invention will be described in detail below with reference to embodiments illustrated in the drawings. In the drawing:

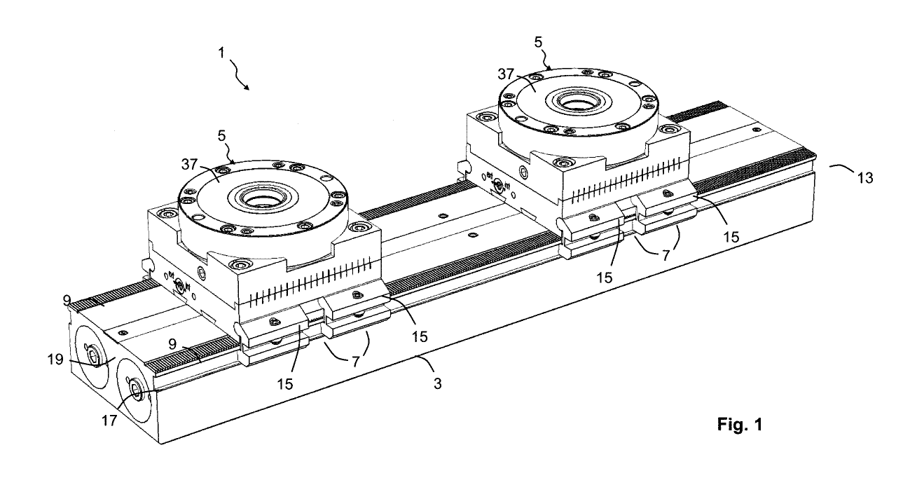

FIG. 1 shows a perspective view of a first embodiment of a coupling unit with two coupling modules according to a first embodiment that are used for fixation to a rail having channels and outlet openings for feeding a pneumatic medium;

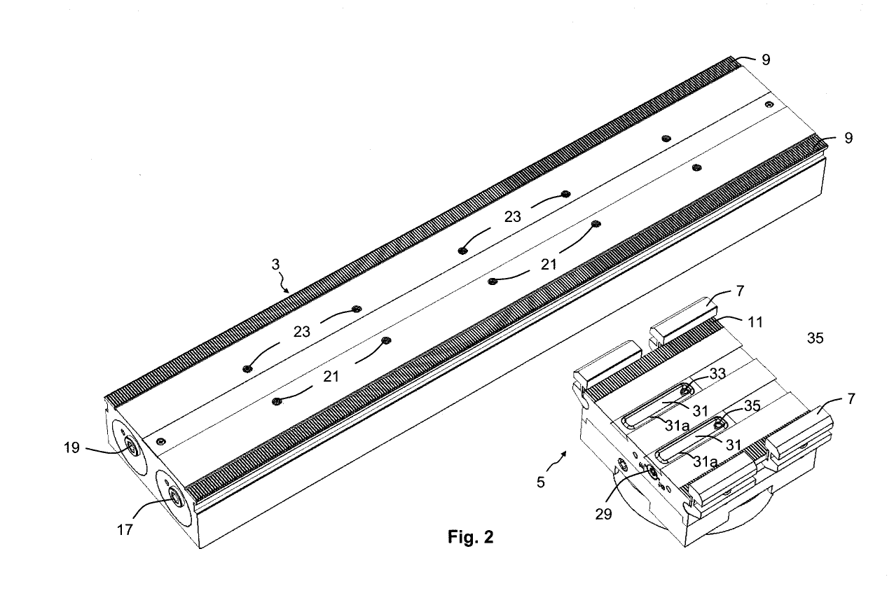

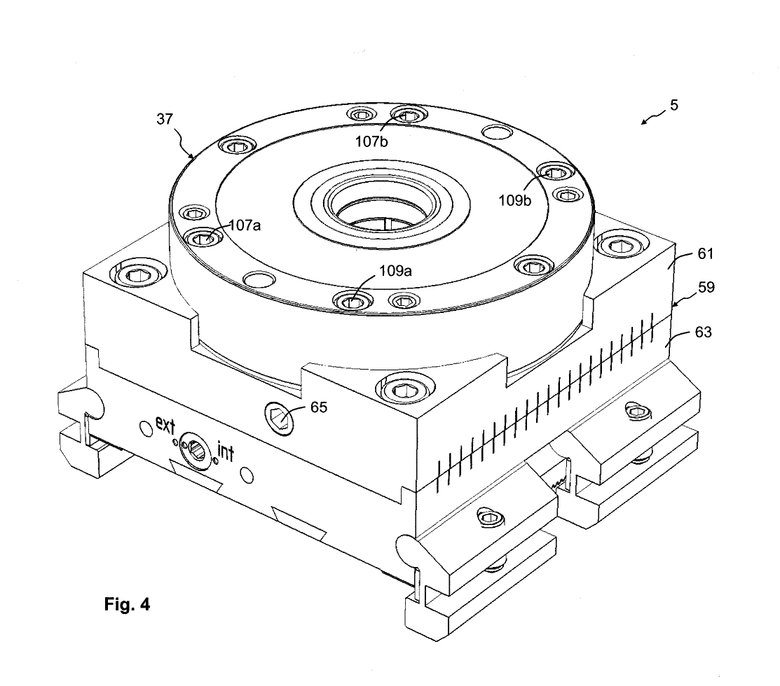

FIG. 2 shows a perspective horizontal view through the lower main body part in FIG. 4 in order to illustrate the channels and directional valves for the pneumatic medium;

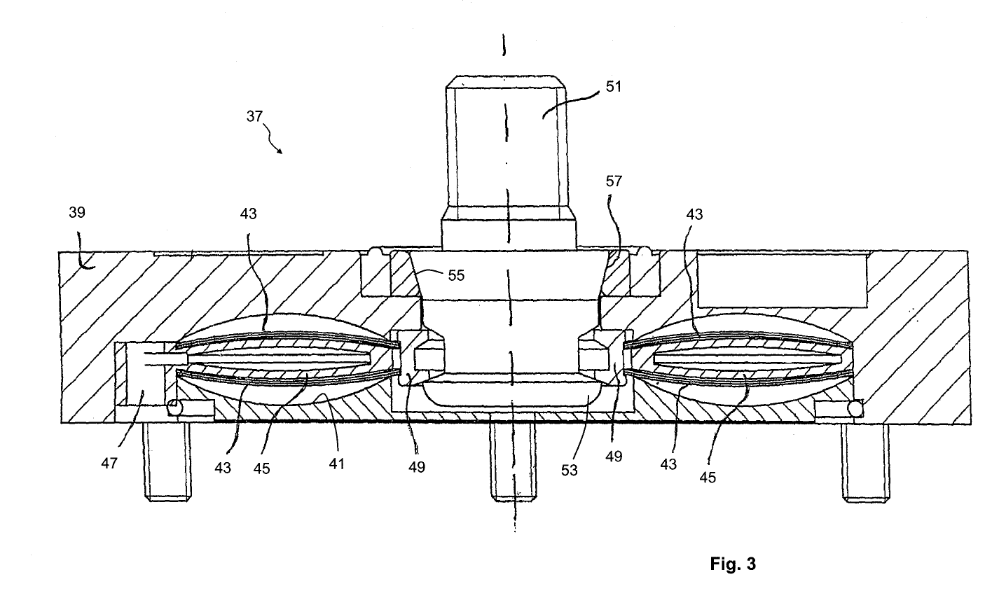

FIG. 3 shows a sectional view of the coupling units for the coupling modules of the coupling unit in FIG. 1;

FIG. 4 shows an enlarged perspective view of a coupling module according to FIG. 1;

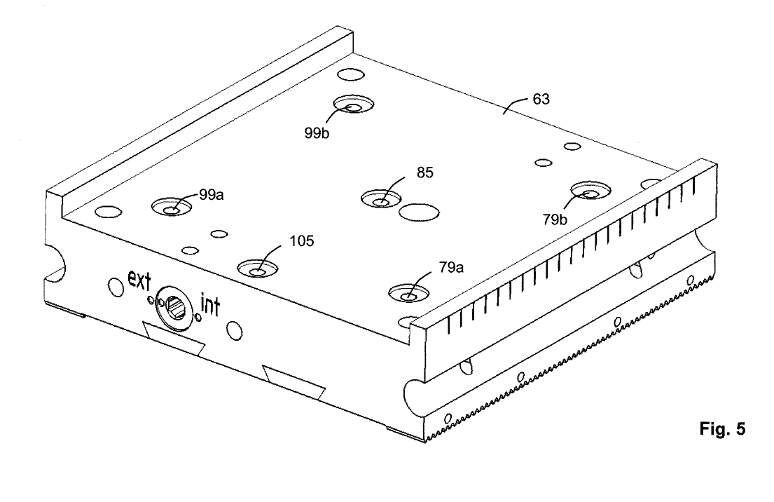

FIG. 5 shows a perspective view of the lower main body part of the coupling module in FIG. 3;

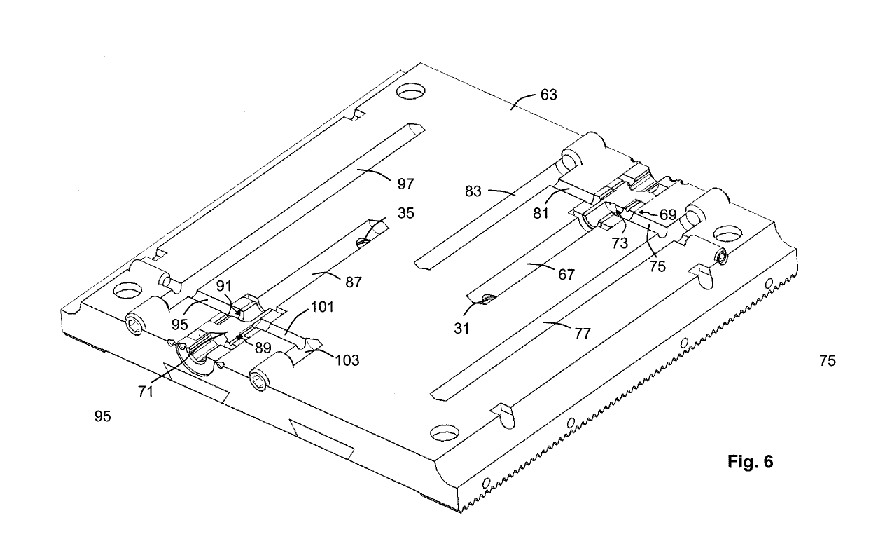

FIG. 6 shows a perspective view of the rail in FIG. 1 and a perspective view from below of a coupling module according to FIG. 1;

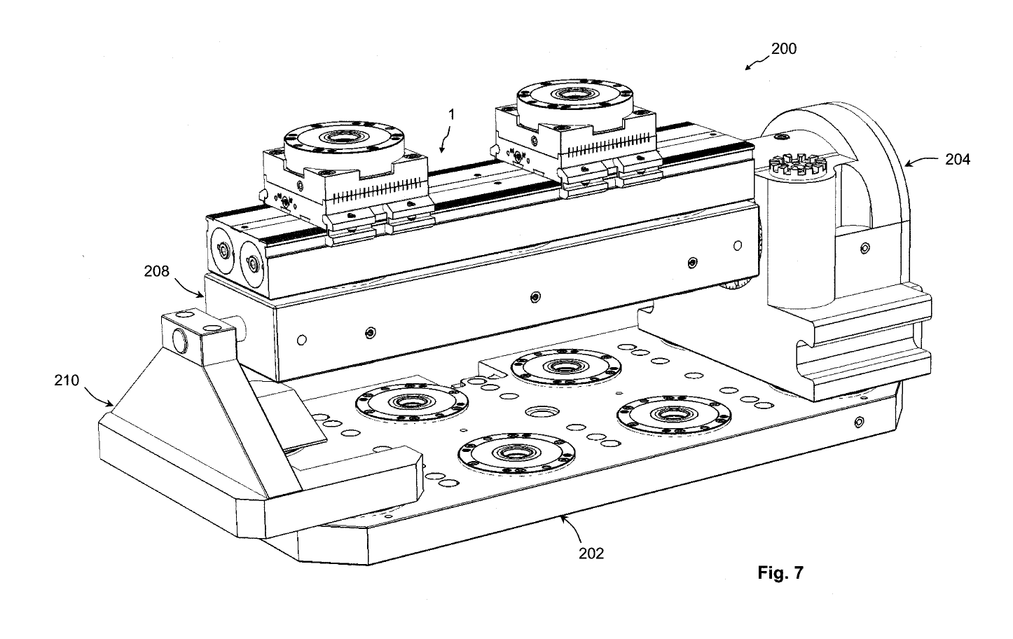

FIG. 7 shows a perspective view of a second variant of the coupling unit with a coupling module formed as a baseplate, a coupling module with a rotationally movable interface area, a linear coupling module on which the coupling unit according to FIG. 1 is locked and a retaining module; and

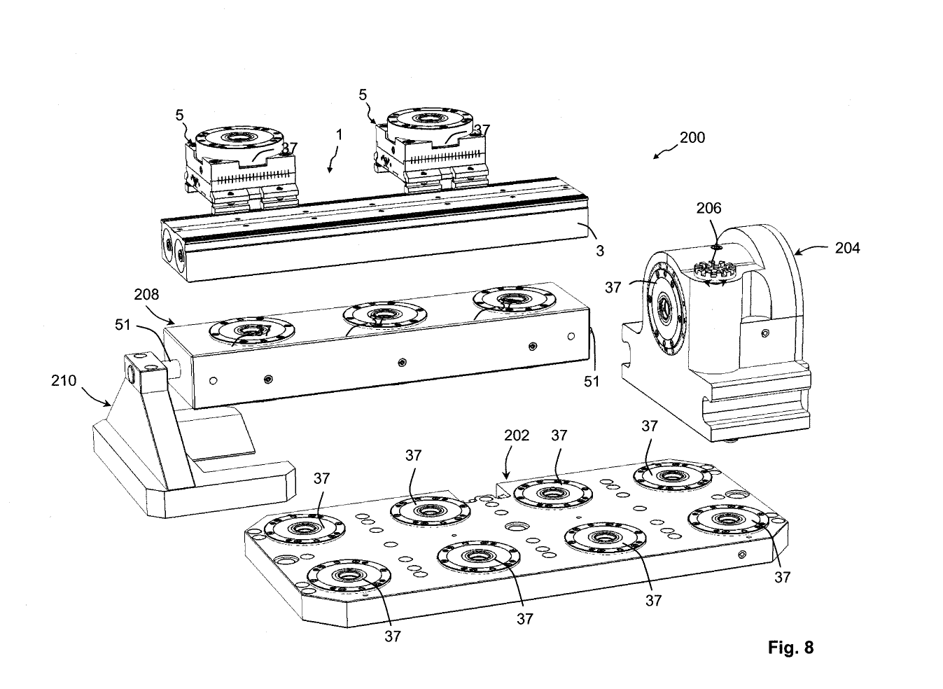

FIG. 8 shows a perspective exploded view of the coupling unit in FIG. 7.

The first variant of a coupling unit 1, shown in FIG. 1 in a perspective view, comprises a rail 3 and two coupling modules 5 mounted thereon, which have on each of the two guide sides two pivotable clamping feet 7, with which the coupling modules 5 can be fixed to the rail 3. For this purpose the rail 1 has respective toothing 9 on the outer edges of its upper side that cooperates with toothing 11 arranged on the underside of the coupling modules 5, in order to securely fix the coupling module 5 in the intended position after tensioning of the clamping feet 7.

A groove 13, into which the clamping feet 7 projecting from the underside of the coupling modules 5 reach, is provided on the lateral outer surface of the rail 3 underneath the toothing 9. The clamping modules 7 are fixed by means of a tensioning screw 15 screwed into a threaded hole in the upper part of each clamping foot 7 and through the upper part of each clamping foot 7 into a groove of the clamping foot. The lower end of each tensioning screw 15 acts on the lower foot part, which is connected by a relatively thin vertical wall to the upper part of each clamping foot 7. The vertical wall acts like a solid-body spring, so that due to the impingement of the tensioning screw 15 onto the lower part of the clamping foot 7, the lower part can be pivoted like a lever about an axis that runs parallel to the longitudinal axis of the rail 3. The lower part of the clamping foot 7 reaching into the groove 13 is pivoted by the action of the lower end of tapping screw 15 and impinges on the upper, horizontal wall of the groove 13. This generates a vertically acting force, with which the coupling module 5 is pulled onto the upper side of the rail 3. In connection with the toothing 9, 11, a secure clamping of the coupling module 5 on the rail 3 is guaranteed. The detailed functioning of the clamping of the coupling modules 5 on the rail 3 can be found in WO 2010/063268 A1.

Longitudinally running channels 17, 19 are provided in the main body of the rail 3, wherein an external compressed air line (not shown) can be coupled to each supply opening for the channels 17, 19 at the end faces of the rail 3.

As can be seen from FIGS. 1 and 2, outlet openings 21, 23, which can be connected respectively to the longitudinal channels 17, 19, are provided on the upper sides of the rail 3. The outlet openings are each formed so as to be closable. As suggested in FIGS. 1 and 2, respective valve screws 25 that can be vertically screwed in are located in the outlet openings, the screws closing off the respective outlet opening 21, 23 in a first position and releasing the outlet opening in a second position, for example one in which they are screwed in further. For this purpose, the corresponding area of the associated channel that leads to the outlet opening 21, 23, can be formed to expand conically to the inside. Thereby a sealing function can be achieved in an upper position of each valve screw 25, whereas the respective outlet opening 21, 23 is released when the valve screw 25 is screwed farther into the widening area of the channel.

Thus a pneumatic medium under pressure can be fed to each channel 17, 19, wherein the outlet opening 21, 23 via which the pneumatic medium can flow to the coupling module 5 located above it can be selected by a corresponding adjustment of the valve screws 25.

As can be seen from FIG. 2, longitudinally movable sealing elements 27, 29, which run substantially sealed against pressure in a dovetail guide on the lower side of the module 5, are provided on the underside of the coupling module 5. Each of the sealing elements 27, 29 has a passage opening 31 formed in the longitudinal direction of the coupling module 5 (or the rail 3), said passage opening being connected in any possible position of the movable sealing element 27, 29 to a respectively associated feed opening 33, 35. The mobility of the sealing elements 27, 29 guarantees that the coupling module 5 can be positioned in an arbitrary position on the rail 3, wherein respectively one outlet opening 21, 23 is activated or opened in order to supply the pneumatic coupling module 5 with pneumatic medium. Even though the outlet openings 21, 23 are provided with a relatively large, preferably equidistant spacing in the longitudinal direction of the rail 3, the mobility of the sealing elements 27, 29 and the relatively long passage opening 31 in the longitudinal direction ensure that the sealing elements 27, 29 can be shifted in every desired position of the coupling module 5 into a position such that a transition of the pneumatic medium from the associated outlet opening 21, 23 into the passage opening 31 of the sealing elements 27, 29, and thus into the associated feed opening 33, 35, is possible.

Without the mobility of the sealing elements 27, 29, there would be a danger that, in certain positions of the coupling module 5 on the rail 3, the respective outlet opening 21, 23 would still be closed off (at least in part) by the underside of the coupling module 5, so that an unhindered passage of the pneumatic medium would not be guaranteed, even if a longitudinal groove corresponding to the passage opening 31 were provided on the underside of the coupling module 5.

A seal 31 a can be provided at the edges of the passage opening 31 of the sealing elements 27, 29 in order to guarantee a pressure-tight transition between the surface of the rail 3 and the coupling module 5.

The coupling module 5 comprises a coupling device formed as a separate coupling unit 37, which has an annular or hollow cylindrical shape. The coupling unit 37 will be described below with reference to the central sectional view of FIG. 3.

The coupling unit 37 comprises a housing 39 having an annular cavity 41 in its interior. Two opposing annular packets of plate springs 43 are arranged in this cavity 41, wherein an annular hose element 45 is arranged between the packets of spring plates 43. Pneumatic medium can be fed to the hose element 45 via a feed opening 47 on the underside of the housing 39 of the coupling unit 37. In the pressure-free state, the inwardly slotted plate springs 43, as a result of their tendency to occupy a flat position, apply a force to several clamping elements 49, each forming a segment of an annular subdivided clamping element. Thus the clamping elements 49 are pressed inward via the force of the inner edges of the plate springs 43 in the depressurized state. In this way it is possible to lock an engagement element 51 in the central recess of the pneumatic coupling element 5.

As shown in FIG. 3, an engagement element can be shaped rotationally symmetrically in the form of a pin and can be furnished on its underside with a collar 53 that is shaped conically inward on its upper side. This collar 53 can be subjected to a force by the lower end face of the clamping element 49, which is likewise formed with a conically inward shape. Due to the inward movement of the clamping elements 49, the engagement element 51 is drawn into the receptacle opening of the coupling module by the interaction of the respective conical surfaces of the clamping elements 49 and the collar 53 of the engagement element 51, until corresponding stop faces 55 of the engagement elements 51 and 57 of the coupling unit 37 interact in such a manner that the inward movement of the engagement element 51 is stopped and the engagement element 51 is securely locked or clamped in the coupling unit 37.

The locking is released by charging the hose element 45 with the pneumatic medium subject to a predetermined pressure. Thereby the annular hose is inflated, whereby the packets of spring plates 43 at the outer sides of the hose element 45, which plates are fixed in the vertical direction at their radially outward and inward terminal areas, are brought into a curved position. Such an intermediate position is shown in FIG. 3. In the end position, which can be defined by a corresponding shaping of the annular cavity 41, the plate springs 43 are curved sufficiently that the radially inward ends have been drawn back sufficiently that the clamping elements 49 are moved radially outward. Thereby the engagement element 51 can be removed from the receptacle opening in the coupling unit 37. The movement of the clamping elements 49 radially outward can also be supported by appropriately arranged spring elements, which are arranged, for example, between the opposing segment-like clamping elements 49.

Thus a secure locking of a clamping element 51 in such a coupling unit 37 is guaranteed in a simple manner. A detailed description of such a coupling unit 37 can also be found, for example, in WO 2007/009439 A1.

The coupling unit according to FIG. 1 thus guarantees the positioning of the coupling module 5 in any desired position on a rail 3. A workpiece or an additional coupling module with appropriately provided engagement elements can be inserted into the receptacle openings of the coupling modules 5 and locked therein.

To install the unit 1, it is merely necessary to place the coupling modules 5 at predetermined positions on the rail 3 and fix them by means of the clamping screws 15. Of course, the matching outlet openings 21, 23 must have been previously provided in the upper side of the rail 3. If the channel 17, 19 that feeds the pneumatic medium via the respective feed opening 33, 35 in the coupling module 5 to the feed opening 47 of the coupling unit 37 is subjected to pressure, then the coupling unit 37 is transferred into the unlocked or release position, so that an engagement element 51 of any desired other unit can be inserted. If the pressure of the pneumatic medium is switched off, then the coupling unit 37 is transferred into the locked position, in which the engagement element 51 is securely retained.

Because the rail 3, owing to the interaction of the teeth 9 and the complementary teeth 11 on the underside of the coupling module 5, allows locking of the coupling module 5 only with a pitch defined by the teeth 9, 11, a two-part construction of the main body 59 of the coupling module 5 and a movable guidance of the upper part 61 in a lower part 63 of the main body 59 guarantees that the coupling units 37 can be adjusted to almost any desired positions of in the longitudinal direction of the rail 3. For this purpose, the upper part 61 of the main body 59 can be moved, preferably continuously variably, relative to the lower part 63 by at least an amount that is greater than half the pitch distance defined by the teeth 9, 11. Of course the displacement path for the upper part 61 relative to the lower part 63 of the base body 59 can also be larger.

An adjusting screw 65 on an end face of the coupling module 5 is shown in FIG. 4, the displacement movement being generated by the adjusting screw via a mechanism that is not shown in detail. Of course, this displacement of the parts 61, 63 relative to one another can also be performed according to a likewise discreet, but much finer pitch. For example, the adjusting screw 65 can be designed to be lockably rotatable, so that the movements can be accomplished according to very small steps, each step being determined by a corresponding angular area of the adjusting screw between two locking positions.

The manner in which the pneumatic medium supplied via the feed openings 33, 35 (FIG. 2) is routed inside the lower part 63 of the main body 59 of coupling module 5 will be described in detail below with reference to FIGS. 5 and 6.

The pneumatic medium fed via the feed opening 31 reaches a first port of a 3/2 directional valve 69 via a longitudinally extending channel 67 of the lower main body part 63. The 3/2 directional valve 69 has an actuating element 71, which is constructed in the direction toward the channel 67 as a hollow cylinder and projects into the channel 67. In the hollow cylindrical part, the actuating element 71 has a radially extending bore 73, which is aligned in the position shown in FIG. 6 with a channel 75 running transverse to the channel 67. Via the channel 67 and the radial bore 73, the pneumatic medium reaches the channel 75, whose feed opening forms a third port of the directional valve 69. The pneumatic medium flows from the channel 75 into another longitudinally extending channel 77, which is formed farther in the direction toward the outer side of the lower main body part 63 relative to the channel 67. Starting from this channel 77, two vertically extending bores, which connect the channel 77 to outlet openings 79a, 79b in the upper side of the main body part 63, are provided in the upper side of the main body part 63.

The channel 67 here forms the first part of a detector channel, which can be connected via the directional valve to a part of a detector coupling channel formed by the channels 75 and 77 and the respective vertical bore. An adjoining further part of the detector coupling channel is formed by the respective axial bore in the coupling unit 37 (see below).

If the actuating element 71 is turned by 180° about its longitudinal axis, then the bore 73 connects the channel 67 to another channel 81 running transversely thereto, the feed opening of which constitutes a second port of the directional valve 69. The channel 81 in turn opens into a longitudinally extending additional channel 83, which terminates roughly in the center of the lower main body part 63. A vertical bore in the lower main body part 63, provided roughly in the center thereof, connects an outlet opening 85 to the channel 83. The channels 81 and 83, as well as the associated vertical bore, form a detector channel which feeds the pneumatic medium to the coupling unit 37 in the “EXTERNAL” position of the directional valve 89.

The feed opening 35 in the underside of the lower main body part 63 opens into a channel 87 that runs in the longitudinal direction and terminates in an area in which another 3/2 directional valve 89 is provided, which is constructed exactly like the 3/2 directional valve 69. This terminal area of the channel 87 forms a first port of the directional valve 89. In the position shown in FIG. 6, a radial bore 91 in the hollow cylindrical part of the actuating element 93 for the valve 89 connects the channel 87 to a channel 95 running transversely thereto and terminating in a longitudinally extending channel 97. The feed opening of the channel 95 forms a third port of the directional valve 89.

The channel 87 thus forms a first part of a supply channel that can be connected via the directional valve 89 to a part of the supply coupling channel formed by the channels 95 and 97; an adjoining part of the second part of the detector channel is formed by the respective axial bore in the coupling unit 37 (see below).

As can be seen from FIG. 5, the channel 97 is in turn connected via two bores to outlet openings 99a, 99b in the upper part of the lower main body part 63, which likewise form parts of the detector coupling channel.

If the actuating element 71 is shifted from the “EXTERNAL” position shown in FIG. 6 to the “INTERNAL” position by a rotation of 180°, then the radial bore 91 connects the channel 87 to another channel 101, which in turn opens into a longitudinally extending relatively short channel 103. The feed opening of the channel 101 forms a second port of the directional valve 89. The channel 103 is in turn connected via a vertical bore to an outlet opening 105 in the upper side of the lower main body part 63. The channels 101 and 103, as well as the vertical bore, form a supply channel that feeds the pneumatic medium to the coupling unit 37 in the “INTERNAL” position of the directional valve 89.

It should be noted at this point that the position of the actuating element 71 for the 3/2 directional valve 69 shown in FIG. 6 is likewise the “EXTERNAL” position.

The outlet openings 79a, 79b, 99a, 99b, 85 and 105 in the upper side of the lower main body part 63 open, in a manner that is not shown, into corresponding bores in the upper main body part 61 that run vertically and are aligned with said outlet openings (in the neutral position of the two main body parts 61, 63). In order to allow displacement of the two main body parts 61, 63 relative to one another without completely closing off the outlet openings, both the outlet openings in the upper side of the lower main body part 63 and the correspondingly associated feed openings on the underside of the upper main body part 61 (not shown) are formed so as to expand radially.

Thus the outlet openings in the upper side of the upper main body part 61 correspond to the configuration of the outlet openings 79a, 79b, 99a, 99b, 85 and 105 in the upper side of the lower main body part 63.

If the coupling unit is placed in the correct azimuthal position on the upper side of the upper main body part 63, then the feed opening 47 on the underside of the coupling unit 37 is aligned with the vertical bore in the upper main body part 61 that is aligned with the outlet opening 105 in the lower main body part 63. Therefore the coupling unit 37 is fed with pneumatic medium when the 3/2 directional valve 89 is switched to the “INTERNAL” position. If pressure is applied in this position of the valve 89, the coupling unit 37 is shifted into the release position.

If the 3/2 directional valve 89 is switched to the external position, then the pneumatic medium is no longer fed to the coupling unit 37, but instead in the direction toward the outlet openings 99a, 99b of the lower main body part 61. These outlet openings are again aligned with vertical bores in the upper main body part 61, which are in turn aligned with corresponding vertical bores in the radially outer peripheral area of the coupling unit 37 and open into outlet openings 107a, 107b. The outlet openings 107a, 107b therefore enable the routing of pneumatic medium through the coupling unit 5 when the 3/2 directional valve 89 is in the “EXTERNAL” position.

Another vertical bore, which is aligned with the outlet opening 85 in the lower main body part 63, is provided in the upper main body part 61 in a manner that is not shown. The bore runs into the upper side of the upper main body part 61 and therefore terminates centrally at a position opposite the end face of an engagement element 51 inserted into the receiving opening of the coupling unit 37. The geometry of the engagement element can be designed in such a manner that, in the locked position, it completely closes off the outlet opening of the respective channel and the upper main body part 61 or measurably influences the flow of the pneumatic medium. In this manner it can be determined by measuring the flow rate or the pressure or differential pressure (at a fixed flow resistance) of the pneumatic medium whether the engagement element 51 is correctly retained in its locked position. If the end face of the engagement element 51 moves sufficiently far away from the surface of the upper main body part 61, then the flow rate of the “measurement” pneumatic medium increases, so that an undesired detachment or incorrect position of the engagement element 51 in the coupling unit 37 can be detected. Because the manner of detecting or measuring the flow rate, the pressure or the differential pressure is not the core of the present invention and is immediately familiar to a person skilled in the art, a detailed description will be forgone at this point.

If the 3/2 directional valve 69 is switched to the “EXTERNAL” position, then the “measurement” pneumatic medium is fed via the outlet openings 79a, 79b in the lower main body part 63 to aligned vertical bores in the upper body part 61, which are in turn aligned with corresponding vertical bores in the coupling unit 37 (if the latter is inserted in the correct azimuthal position), so that the “measurement” pneumatic medium is fed to additional outlet openings 109a, 109b in the upper side of the coupling unit 37. In this manner the “measurement” pneumatic medium can also be routed through the coupling module 5 if the 3/2 directional valve 69 is in the “EXTERNAL” position.

The modules illustrated in FIGS. 1-6 in the form of the rail 3 and the coupling modules 5 can of course also be produced in a number of other variants.

Instead of pivotable clamping feet 7 on the underside, the coupling module 5 can have a pin-like engagement element for example, which is designed in such a manner that it can be received in a receiving area of a coupling unit 37 arranged on an additional coupling module.

Of course the main body of the coupling module 5 illustrated in FIG. 1 can also be constructed as a single unit if the movable function of the two main body parts can be forgone.

The rail 3 can likewise be varied in such a manner that engagement elements on its underside are provided, with which the rail can be retained in a coupling module located underneath, in which for example one or more coupling units 37 are in turn arranged. The pneumatic medium can be fed through feed openings formed on the underside of the rail 3 that are aligned with the outlet openings 107a, 107b or 109a, 109b on the upper side of each coupling unit 37.

In the same manner, it is possible to forgo the possibility shown in FIG. 1 of providing connections for feeding pneumatic medium via an end face of the rail (feed opening 17, 19), and instead, engagement elements can be provided on one or both end faces.

The more complex coupling unit 200 shown in FIGS. 7 and 8 consists of a coupling module 202 formed as a baseplate, wherein several coupling units 37 (eight in the illustrated example) are housed in the plate-like main body of the coupling module 202. The feed opening 47 of each coupling unit 37 is connected to a supply channel for feeding pneumatic medium inside the main body of the coupling module 202. Each of the supply channels leading to a coupling unit 37 can branch off from a manifold supply channel (not shown), so that the pneumatic medium for actuating the coupling unit 37 can be fed via a single feed opening to the plate-like coupling module 202. A 3/2 directional valve, which is constructed in the manner described above in connection with FIGS. 1-6, can in turn be arranged in each supply channel leading from the manifold supply channel to the coupling units 37. An actuating element for either feeding pneumatic medium to the coupling units 37 (“INTERNAL” position) in order to actuate the locking function of the coupling unit 37 or for routing the pneumatic medium via each of the coupling units 37 in the above-described manner (“EXTERNAL” position) is then available for each of the coupling units 37.

If it is guaranteed that a coupling module with several coupling devices, in the form of coupling units 37, for example, is operated in such a manner that two or more coupling devices or coupling units are always used simultaneously, then of course only a single directional valve can be used in place of two or more directional valves, each assigned to a single coupling device, the structure of the channels for routing the pneumatic medium being selected in such a manner that either the two or more coupling devices are simultaneously operated (“INTERNAL” switching position of the single directional valve) or the pneumatic medium is routed simultaneously via the two or more coupling devices (“EXTERNAL” switching position of the single directional valve).

In the coupling unit in accordance with FIGS. 8 and 9, an additional special coupling module 204 is placed on the plate-like coupling module 202; on the main body of the latter, two engagement elements 51 provided on the underside are held in the receiving openings of two adjacent coupling units 37 in the coupling module 202.

To install the coupling module 204 on the plate-like coupling module 202, the two directional valves associated with the coupling units 37 arranged at the right-hand peripheral area are first switched to the “INTERNAL” position. Then pneumatic medium is fed under pressure to the coupling module 202. Thereby the coupling units 37 are shifted to the release position, so that the engagement elements 51 located on the underside of the main body or the coupling module 204 can be inserted into the receiving areas of the coupling units 37.

Of course the plate-like coupling module 202 can likewise have a directional valve for each coupling unit 37 separately, or a valve for several coupling units as described above, with which each associated coupling unit or the respectively associated multiple coupling units 37 can be supplied with “measurement” pneumatic medium. The directional valves can likewise initially be in the “INTERNAL” position so that the proper positioning of the inserted coupling module 204 can be checked. Then the directional valves for the two right-hand coupling units 37 can be switched to the “EXTERNAL” position, so that the “measurement” medium can be routed through the respective coupling units 37 and fed to the coupling module 204.

The coupling module 204 can be provided with feed openings for the “measurement” pneumatic medium on its underside in one or both interface areas on which the coupling module 204 lies in the area of a coupling unit 37 on the surface of the coupling module 202.

The coupling module 204 is constructed in such a manner that, on the inward facing side surface, a coupling unit 37 is retained in the housing of the coupling unit 204 rotatably about a horizontal axis that is aligned with the axis of the coupling unit 37. The coupling unit 37 in the housing of the coupling module 204 can be rotated by turning the control wheel 206 about a vertical axis manually or by means of a device that is not shown in detail.

The coupling module 37 is received in the housing of the coupling module 204 in such a manner that it can be actuated pneumatically in the previously described manner. For this purpose, of course, appropriate channels for the pneumatic media must be provided, which allow an actuation of the locking function or the releasing function in every angular position of the coupling unit 37 when the coupling module 204 is fed pneumatic medium by the coupling module 202.

The coupling module 204 can of course also comprise an actuating element 71, with which the pneumatic medium is routed to actuate the coupling unit 37.

In the same manner, the coupling module 204 can of course have a function for detecting the correct locking of an engagement element in the receiving area of the coupling unit 37. For this purpose, a corresponding “measurement” channel that again terminates centrally behind the receiving area of the coupling unit 37 must be provided as described above. The “measurement” pneumatic medium can likewise be routed through the coupling unit 37 with a directional valve in the above-described manner and provided to the respective downstream coupling module.

The embodiment of a coupling unit 200 illustrated in FIGS. 7 and 8 further comprises a coupling module 208 with a beam-like design, in which three coupling units 37 are arranged. The main body of the coupling module 208 can, like the rail in FIG. 1, comprise two longitudinal channels for feeding the pneumatic medium in order to actuate the coupling unit 37 or for feeding the “measurement” pneumatic medium. Separate supply channels or detector channels for each coupling unit 37, with a directional valve arranged in the manner described above in each of said channels, can branch off from the respective manifold supply channel or manifold detector channel. Only the actuating elements 71 for three of the six directional valves are shown in FIGS. 7 and 8 on the long side of the coupling module 208.

On its right end face, the coupling module 208 has a pin-like element 51, which engages in the receiving area of the coupling unit 37 for the coupling module 204. Of course, appropriate feed openings, each aligned with at least one of the outlet openings 107a, 107b or 109a, 109b, are provided on this end face 208 for feeding the pneumatic medium for operating the coupling units 37 or for feeding the “measurement” pneumatic medium.

On the opposing end face, the coupling module comprises a pin-like engagement element 51, which ensures that the coupling module 208 can rotate in a working module 210 that rotatably supports it.

For assembly, the working module 208, already inserted with its left engagement element 51 into the guide of the working module 210, can first be inserted with its engagement element 51 provided on the right end face into the coupling unit 37 of the coupling module 204, and then the working module 210 can be mounted on the coupling module 202. For this purpose, the working module 210 comprises on the underside of its two arms an engagement element, respectively engaging in one of the two left-hand coupling units 37 of the coupling module 202.

Because the working module 210 is not operated pneumatically, it is not necessary to switch the directional valves of the two left-hand coupling units 37 arranged in the coupling module 202 to the “EXTERNAL” position.

Finally, the coupling unit 200 according to FIGS. 7 and 8 can also comprise a unit 1 according to FIGS. 1-6, wherein the rail 3 can comprise two or three engagement elements on its underside, each of which can engage with the receiving area of a coupling unit 37 of the coupling module 208. The coupling units 37 of the module 208 can be actuated with respect to the locking position or release position and also with respect to the correct holding of the engagement elements of rail 3, because both the “supply” pneumatic medium and the “measurement” pneumatic medium are routed by module 202 via the module 204 to the module 208.

Even from the two variants illustrated in FIGS. 1-8, it is clear that a great number of different variants of coupling units can be produced with a modular clamping system according to the invention that consists of several types of differently constructed coupling modules. It is of course also possible to use several coupling modules of the same type in a coupling unit. It would make good sense to use a coupling module 202 with a plate-like design as the basis, one or more additional coupling modules of a different or the same type then being mounted on this coupling module 202.

By routing pneumatic medium up to the last coupling module, it is also possible to use a working module that can be operated pneumatically as the last module. For example, this can be a module that has pneumatically operable clamps. The clamping function is preferably configured in such a manner that a release is enabled by application of pressure and the clamping of an element such as a workpiece is enabled by the absence of pressure.

1. Pneumatic coupling module, in particular for a zero-point clamping system,
(a) with a least one pneumatically operable coupling device, to which the pneumatic medium can be fed via a supply channel and which is constructed in such a manner that the coupling device occupies a release position in its pressurized state and a locked position in its non-pressurized state,
(b) wherein the coupling module comprises an interface area for coupling an additional pneumatic module or pneumatically operable working module,
characterized in that,
(c) a directional valve is provided in the supply channel, comprising a first port, which is connected to a first part of the supply channel feeding the pneumatic medium, a second port, which is connected to a second part of the supply channel leading to the coupling device, and a third port, which is connected to a supply coupling channel, the at least one outlet opening of which is arranged in the interface area in such a manner that the outlet opening can be coupled in a substantially sealed manner to an inlet opening of the supply channel of the additional pneumatic coupling module or pneumatically operated working module,
(d) wherein the directional valve connects the first and the second ports in a first switching position (“INTERNAL”) in such a manner that the first part of the supply channel is connected to the second part of the supply channel and the coupling device is controlled to assume its release position and wherein the directional valve disconnects the first port from the third port in the first switching position, whereby no pneumatic medium can be fed to the supply coupling channel, and
(e) wherein the directional valve disconnects the second port from the first port in a second switching position (“EXTERNAL”) and connects the first and third ports in such a manner that the first part of the supply channel is connected to the supply coupling channel and pneumatic medium can be fed to the supply coupling channel and that no pneumatic medium can be fed via the second part of the supply channel to the coupling device and it is controlled to assume its locked position.

2. Clamping or coupling module according to claim 1, characterized in that
(a) a respective detector channel, to which pneumatic medium can be fed, is provided for each or selected coupling devices, each detector channel being constructed in such a manner that its cross section is reduced or completely closed in the presence of an engagement element in the locked position of the associated coupling device, so that the presence or correct positioning of an engagement element in the locked position can be detected by a measurement of pressure, differential pressure or flow rate,
(b) in that a directional valve is provided in the supply channel, comprising a first port, which is connected to a first part of the detector channel, which feeds the pneumatic medium, a second port, which is connected to a second part of the detector channel, which leads from the directional valve to the coupling device, and a third port, which is connected to a detector coupling channel, the at least one outlet opening of which is arranged in the interface area in such a manner that the outlet opening can be coupled in a substantially sealed manner to at least one inlet opening of a detector channel or a manifold detector channel of an additional pneumatic coupling module or pneumatically operated working device,
(c) wherein each directional valve connects the first and the second ports in a first switching position (“INTERNAL”) in such a manner that the first part of the detector channel is connected to the second part of the detector channel, and disconnects the first port from the third part, whereby no pneumatic medium can be fed to the detector coupling channel, and
(d) wherein the directional valve disconnects the second port from the first port in a second switching position (“EXTERNAL”) and connects the first and third ports, so that the first part of the detector channel is connected to the detector coupling channel and pneumatic medium can be fed to the detector coupling channel.

3. Coupling module according to claim 1 or 2, characterized in that the at least one coupling device has at least one separate coupling unit which is housed in a main body of the coupling module in the interface area and in that the at least one directional valve is provided in the main body.

4. Coupling module according to claim 3, characterized in that each coupling unit comprises at least one channel that forms a part of the respective supply coupling channel, the at least one outlet opening of the respective supply coupling channel preferably being provided on the coupling unit.

5. Coupling module according to claim 3 or 4, characterized in that each coupling unit comprises at least one channel that forms a part of the respective detector coupling channel, the at least one outlet opening of the respective detector coupling channel preferably being provided on the coupling unit.

6. Coupling module according to one of the preceding claims, characterized in that at least two coupling devices are provided and in that the at least two first parts of the supply channels branch off from a single manifold supply channel to which pneumatic medium can be fed via a feed opening.

7. Coupling module according to one of claims 2-6, characterized in that at least two coupling devices are provided and in that the at least two first parts of the detector channels branch off from a single manifold detector channel to which pneumatic medium can be fed via a feed opening.

8. Coupling module according to one of the preceding claims, characterized in that the coupling module comprises an additional interface area, at which the coupling module can in turn be coupled to a first interface area of an additional coupling module, wherein at least one engagement element for engaging in the coupling device of the additional coupling module is provided in the additional interface area, and wherein at least one feed opening of the supply channel or the manifold supply channel and, if applicable, also at least one feed opening of the detector channel or the manifold detector channel is arranged in the additional interface area in such a manner that said opening can be connected to the at least one outlet opening of the supply coupling channel or of the detector coupling channel of the additional coupling module in a substantially leak-free manner.

9. Coupling module according to claim 8, characterized in that the coupling module has a main body formed in two parts, wherein a first part of the main body comprises the at least one coupling device and a second part of the main body comprises the at least one engagement element and in that the two parts of the main body are guided movably relative to one another with at least one degree of freedom, preferably about a single rotational axis or in a single translational direction.

10. Coupling module according to claim 9, characterized in that the at least one directional valve is provided in the supply channel and, if applicable, the at least one directional valve is provided in the detector channel in the second part of the main body.

11. Coupling module according to one of the preceding claims, characterized in that a manually operable actuation device is provided for each directional valve or for each group of directional valves.

12. Modular clamping system, in particular for a machine tool, consisting of several types of differently constructed coupling modules according to one of the preceding claims, wherein, with respect to the engagement elements and with respect to the feed openings for the supply channels or manifold supply channels, and if applicable, the feed openings for the detector channels or manifold detector channels, and with respect to the outlet openings of the supply coupling channels and, if applicable, the outlet openings of the detector coupling channels, the types of coupling modules are constructed in such a manner that similarly and differently constructed coupling modules can be coupled at least in predetermined combinations.

13. Modular clamping system according to claim 12, characterized in that at least one type of working module having at least one engagement element is provided.

14. Modular clamping system according to claim 13, characterized in that the working module is constructed as a manually or pneumatically operable tensioning or clamping means for fixation of a workpiece.
